(19) United States
(12) Patent Application Publication
(10) Pub. No.: US 2016/0067800 A1
(43) Pub. Date: Mar. 10, 2016

(54) Table Top and Throat Plate for Power Table Saws

(71) Applicants: Andrew Frolov, Glenview, IL (US); Zhu Rong, Nanjing (CN)

(72) Inventors: Andrew Frolov, Glenview, IL (US); Zhu Rong, Nanjing (CN)

(73) Assignees: ROBERT BOSCH GMBH, Stuttgart (DE); ROBERT BOSCH TOOL CORPORATION, Broadview, IL (US)

(21) Appl. No.: 14/848,410

(22) Filed: Sep. 9, 2015

Related U.S. Application Data
(60) Provisional application No. 62/047,974, filed on Sep. 9, 2014.

(51) Int. Cl. B23D 45/06; B23D 57/00; B23D 47/02

(52) U.S. Cl. CPC B23D 45/06; B23D 47/025; B23D 57/0092

(57) ABSTRACT

A modular table for a table saw includes extruded components that can be selectively mounted to a table frame according to the operator's or manufacturer's desire. A fixed extruded table section may be used for left and right fixed table sections or for one fixed and one sliding table section. The table frames are also extruded and can be used interchangeably on the front or back of the power tool. Likewise, front and rear rails used to mount an extension table to a fixed table section are also extruded and interchangeable. An extruded throat plate is provided that can be removably mounted to the table frame.

### PRIORITY CLAIM AND REFERENCE TO RELATED APPLICATION

This application is a utility application based on and claiming priority to provisional application No. 62/047,974, filed on Sep. 9, 2014, the entire disclosure of which is incorporated herein by reference.

### BACKGROUND

The disclosure relates to power tools and particularly to power tools integrated into a table that provides a work surface for supporting the workpiece, such as power table saws.

A number of power tools have been produced to facilitate forming a work piece into a desired shape. One such power tool is a table saw. A wide range of table saws are available for a variety of uses. Some table saws, such a cabinet table saws, are very heavy and relatively immobile. Other table saws, sometimes referred to as jobsite table saws, are relatively light and portable so that a worker can position the table saw at a job site. Some accuracy is typically sacrificed in making a table saw sufficiently light to be mobile. The convenience of locating a table saw at a job site, however, makes job site table saws very desirable in applications such as general construction projects.

There is a continuing benefit to reducing the cost and complexity of manufacturing table saws. There is a further benefit in providing table saws that can accurately support the workpiece while still retaining the benefit of low-cost and complexity.

### SUMMARY

A modular table for a power tool comprises a base configured to be seated on a surface, an undercarriage assembly supporting working components of the power tool including a saw blade and a table assembly mounted on the base and supporting the undercarriage assembly. The table assembly includes a table frame, a selection of table sections removably mounted to the table frame, the table sections selected from the group including a fixed table section, a table extension including rails for mounting to the table frame, and a sliding table section including a sliding frame for slidably mounting to the table frame, and a throat plate removably mounted to a table frame, the throat plate defining a slot for receiving the saw blade therethrough. In one aspect, the fixed table section is configured to be removably mounted at either end of the width of the table assembly.

In one feature, the table frame includes identical extruded frame members extending along the width of the table assembly on opposite sides thereof, the frame members including an elongated flange defining a plurality of openings therethrough. Each of said fixed table sections includes a bolt channel for receiving fasteners configured to engage the plurality of openings and the bolt channel of each fixed table section mounted to the table frame. The table extension includes opposite rails configured to engage the opposite channels of the frame members.

In another aspect, the throat plate is an elongated plate and includes a latch element at the opposite ends thereof, each latch element configured to engage the table frame. One of the elongated frame members includes a ledge fastened to the flange, and one of the latch elements includes a plate fastened to the throat plate and arranged to extend between the ledge and the flange of the one elongated frame member. The other of the latch elements includes a spring-biased element configured to engage the flange of the other of the elongated frame members when the one latch element is engaged to the one elongated frame member. The other of the latch elements may include a manually engagable lever operable to move the spring-biased element away from the flange to disengage the throat plate from the table frame. The throat plate may be provided with an opening through which the lever may be engaged.

In another aspect of the disclosure, the table sections and the throat plate are extruded. The table frame members may also be extruded. The extruded components may combined as desired by the operator or manufacturer to form the table for the table saw.

### DESCRIPTION OF THE DRAWINGS

FIG. 1 is a perspective view of a table saw according to the disclosure.

FIG. 2 is a side view of the table saw shown in FIG. 1.

FIG. 3 is side cut-away view of the table saw shown in FIGS. 1-2 incorporating a safety mechanism and drive belt assembly according to one aspect of the disclosure, with the cutting blade in a first operating position.

FIG. 4 is a side cut-away view of the table saw shown in FIG. 3, with the cutting blade in a second retracted position.

FIG. 5 is a side cut-away view of the table saw shown in FIG. 4, with the cutting blade in a further retracted position.

FIGS. 6A, 6B, and 6C are perspective, front and side views of a table saw power tool incorporating a modular extruded construction according to the disclosure.

FIG. 7 is a diagrammatic representation of a layout for the table saw shown in FIGS. 6A, 6B, and 6C.

FIG. 8 is a side view of the table saw layout shown in FIG. 7.

FIG. 9 is a perspective view of a tubular sub-base for use in the table saw of FIGS. 6A, 6B, and 6C.

FIGS. 10A and 10B are a top perspective view of a table assembly for use with the table saw shown in FIGS. 6A, 6B, and 6C.

FIGS. 11A, 11B, and 11C include a chart and diagrams showing modular components of the table saw shown in FIGS. 6A, 6B, and 6C with different combinations of components.

FIGS. 12A and 12B are views of extruded table sections mounted to a table frame.

FIG. 13 is an end view of a table with extruded end sections.

FIG. 14 includes end views of the extruded front and rear rails for the table saw shown in FIGS. 6A, 6B, and 6C.

FIGS. 15A and 15B are perspective and end views of an extruded frame of the table saw shown in FIGS. 6A, 6B, and 6C.

FIGS. 16A and 16B are front views of extruded table sections for use in forming the table assembly shown in FIG. 10A.

FIGS. 17A, 17B, 17C, and 17D are top, perspective and bottom views of the table assembly shown in FIG. 9 in different configurations.

FIGS. 18A and 18B are perspective and end views of an extruded throat plate for use in the table assembly of FIG. 10A.

FIG. 19 is a bottom view of the table assembly shown in FIG. 10A particularly showing a throat plate and insert according to one aspect of the disclosure.

FIG. 20 is a perspective view of the zero clearance insert of FIG. 19.

FIGS. 21A, 21B, and 21C are views of the insert of FIG. 19 engaged within a throat plate.

FIGS. 22A and 22B are detail views of a rear latch for fastening the throat plate to the table assembly.

FIG. 23 is a side cut-away view of the table assembly showing the throat plate mounted within the fixed table section.

FIGS. 24A, 24B, 24C, and 24D are bottom perspective and side views of a front latch assembly for fastening the throat plate to the table assembly.

FIGS. 25A, 25B, and 25C include views of hardened plates for use with the throat plate disclosed herein.

FIG. 26A and 26B includes views of the hardened plates mounted to the throat plate.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the disclosure includes any alterations and modifications to the illustrated embodiments and includes further applications of the principles of the disclosure as would normally occur to one skilled in the art to which this disclosure pertains.

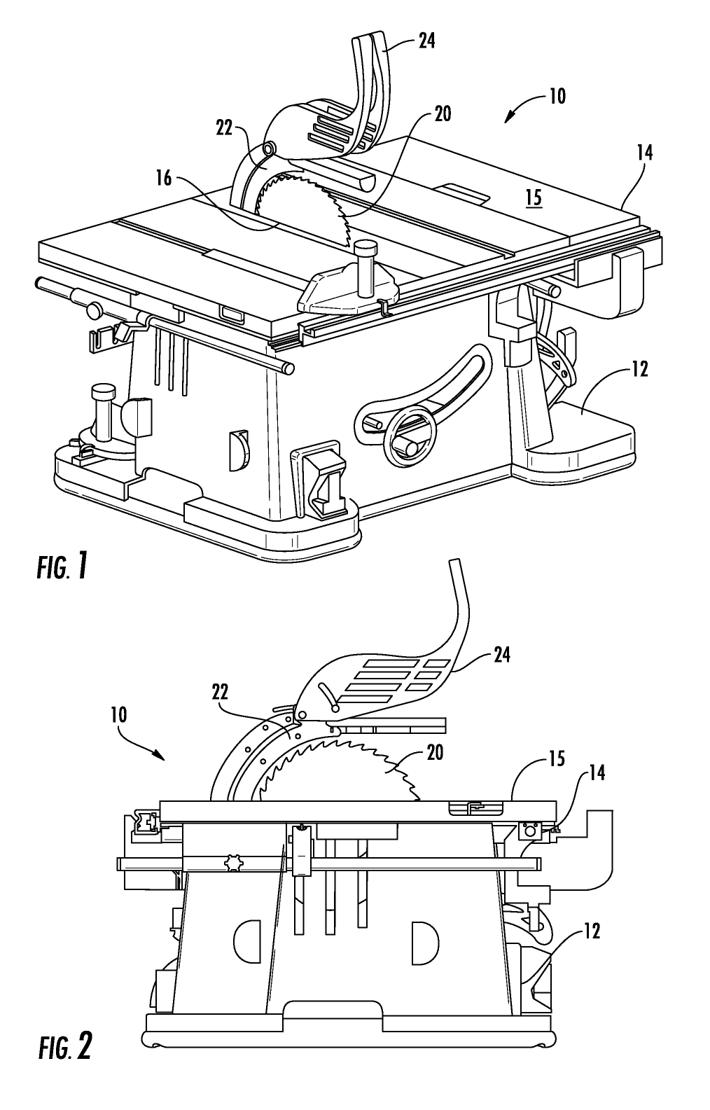

A power tool, and particularly a table saw 10, is shown in FIGS. 1-2 that incorporates certain features disclosed herein. The table saw 10 includes a base 12 that is configured to be supported on a work surface and is further configured to enclose and contain the working components of the saw, as is conventional in the art. It is understood that the base 12 may be configured for portability, as shown in the figures, or may be a cabinet base that is kept in a generally fixed location. The base 12 supports a table 14 that provides the working surface 15 on which the workpiece is supported for the cutting/shaping operation. The table 14 defines a blade slot 16 for receiving a rotary saw blade 20. A riving knife assembly 22 is supported above the saw blade and a blade guard 24 may be pivotably mounted to the riving knife. The riving knife and blade guard are conventional safety features to reduce the likelihood of injury to the tool operator and to help prevent the operator from moving his/her hands into the saw blade.

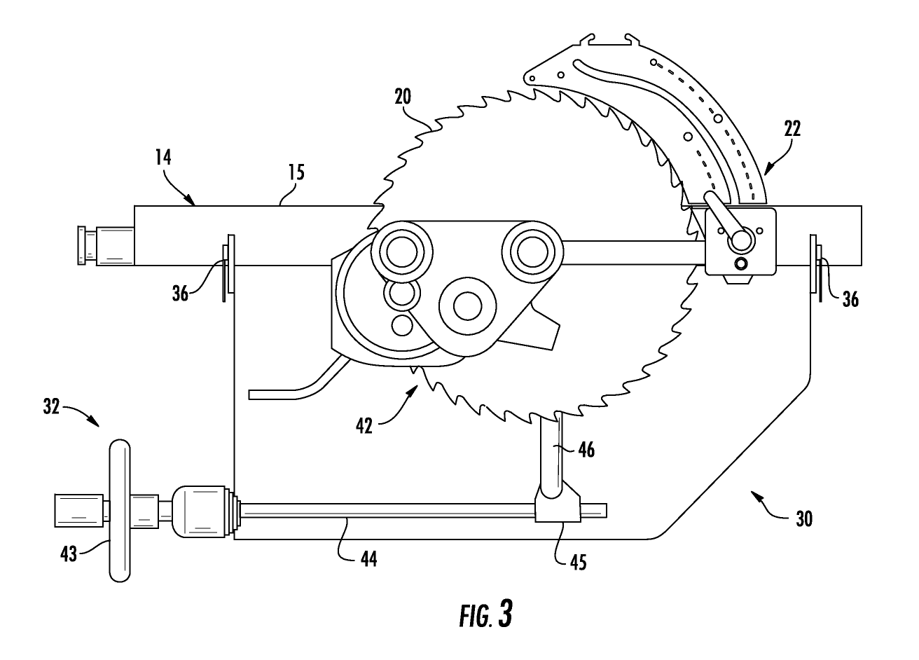

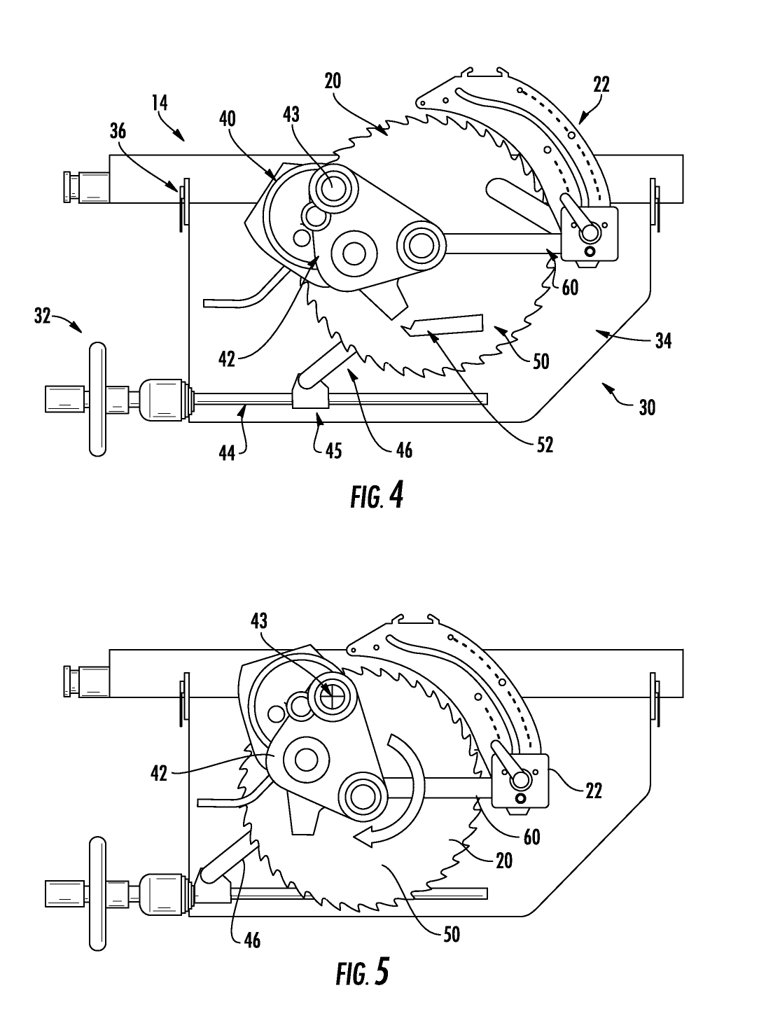

A general schematic of the components of the table saw 10 is shown in FIGS. 3-5. In particular, the table saw includes an undercarriage assembly 30 that includes an undercarriage component 34 configured to support the working components of the tool underneath the table 14. The undercarriage assembly 30 may be supported on the table by a pair of pivot brackets 36 that allow the assembly 30 as well as the saw blade 20 to be pivoted to a desired bevel angle, as is known in the art. An elevation and bevel mechanism 32 is provided that can be used to adjust the bevel angle (or the amount of pivot about the brackets 36) as well as the height of the saw blade 20 above the surface 15 of the table. For instance, the mechanism 32 may include a hand crank 43 that can be used to rotate elevation screw 44. A nut 45 traverses the length of the elevation screw as the screw rotates. An elevation link 46 is mounted at one end to the elevation nut and at an opposite end to a drive assembly 42 that supports the saw blade. Thus, as the screw 44 is rotated in one direction the nut 45 advances toward the free end of the screw, which in turn moves the link 46 from the angled position shown in FIGS. 4-5 to the generally perpendicular position shown in FIG. 3. The elevation mechanism can thus move the saw blade from the maximum height above the work surface 15 shown in FIG. 3 to the maximum depth below the work surface shown in FIG. 5.

As further shown in FIGS. 4-5, the table saw 10 includes a belt and arm drive assembly 42 that couples the saw blade 20 to a drive motor, as described herein. In one aspect of the disclosure, the belt and arm drive assembly 42 is pivotably mounted at a pivot axis 43 to the undercarriage 34 so that the entire assembly, including the saw blade, can pivot, as depicted in FIGS. 4-5. The drive assembly 42 is connected to a riving knife linkage assembly 60 that is configured to maintain the riving knife at a consistent distance from the saw blade 20, even as the drive assembly and baled are pivoted between the maximum height and the maximum depth positions described above.

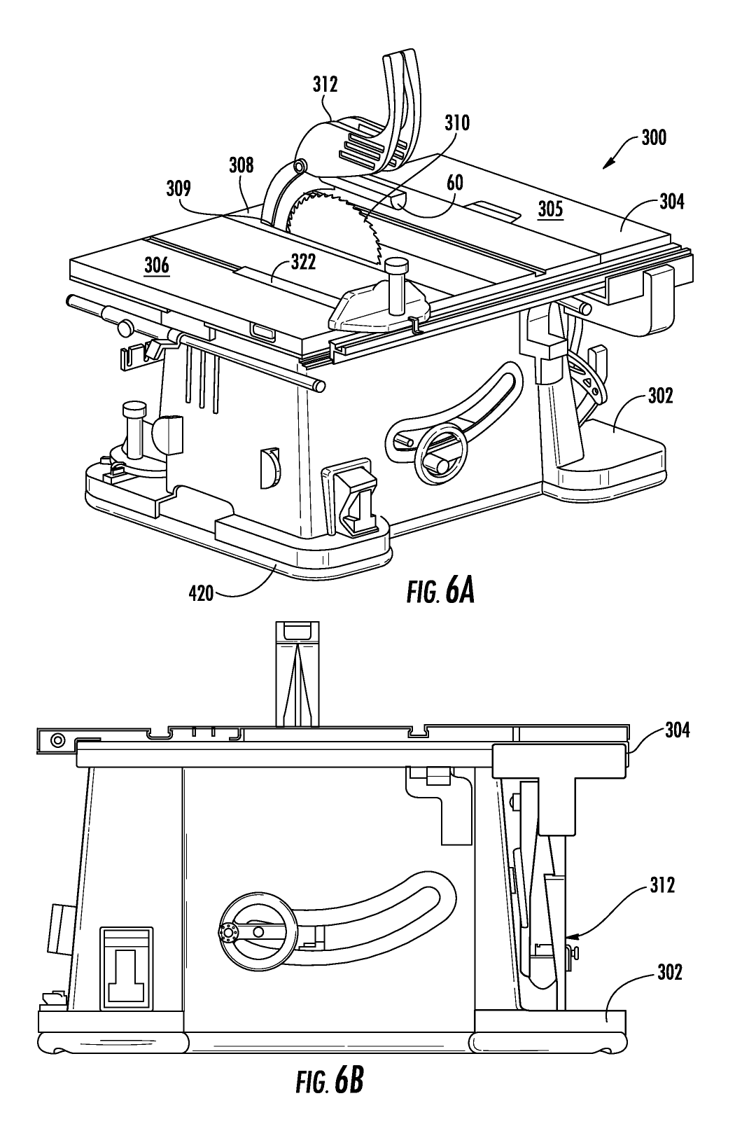

A table saw 300 is shown in FIGS. 6A, 6B, and 6C that incorporates a modular structure and a compact storage envelop for the table saw components. The table saw 300 includes a base 302 that supports a table assembly 304, which assembly may include a fixed table 305 and a sliding table 306. A modular throat plate 308 is mounted to the fixed plate and defines a blade slot 309 through which the saw blade 310 projects in its operating position. The table saw further includes a riving knife and blade guard assembly 312, which may be of conventional construction. FIG. 6C further illustrates the storage configuration for the table saw 300 in which the saw blade is retracted to the position 310′ and the components of the riving knife and blade guard assembly 312′ are stored underneath the table assembly 304. The components are thus stored within the envelop defined by the base 302 and the table assembly 304 to reduce the overall dimension of the power tool for storage.

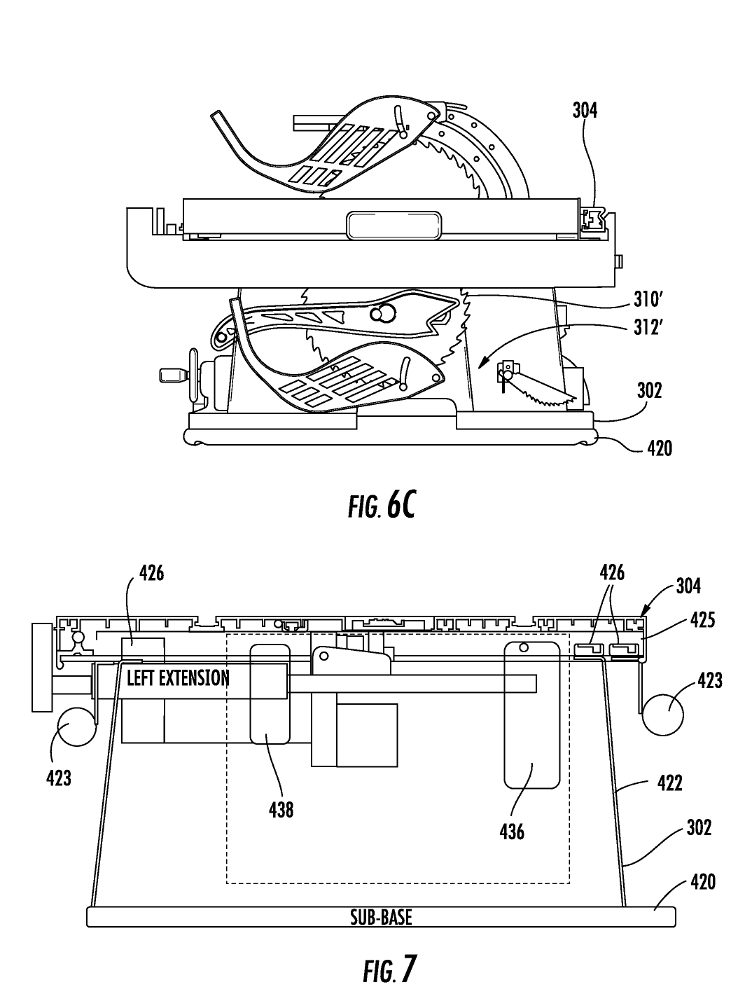

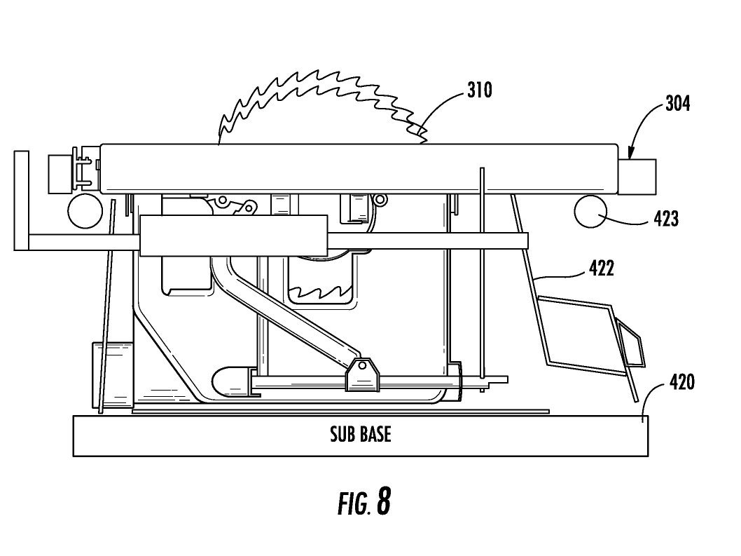

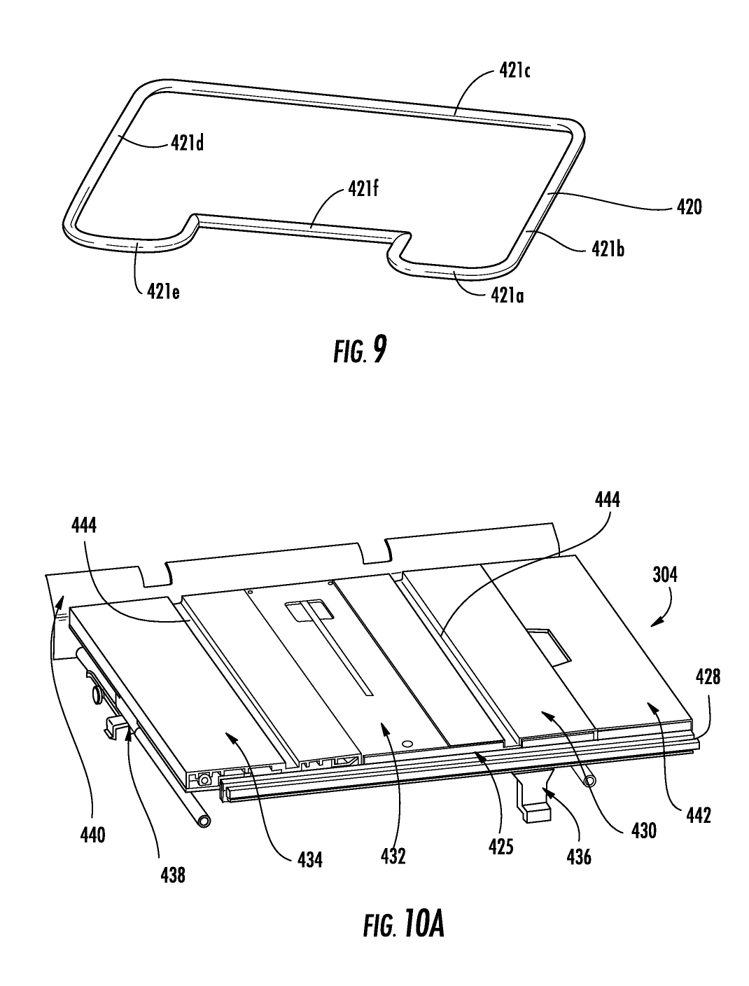

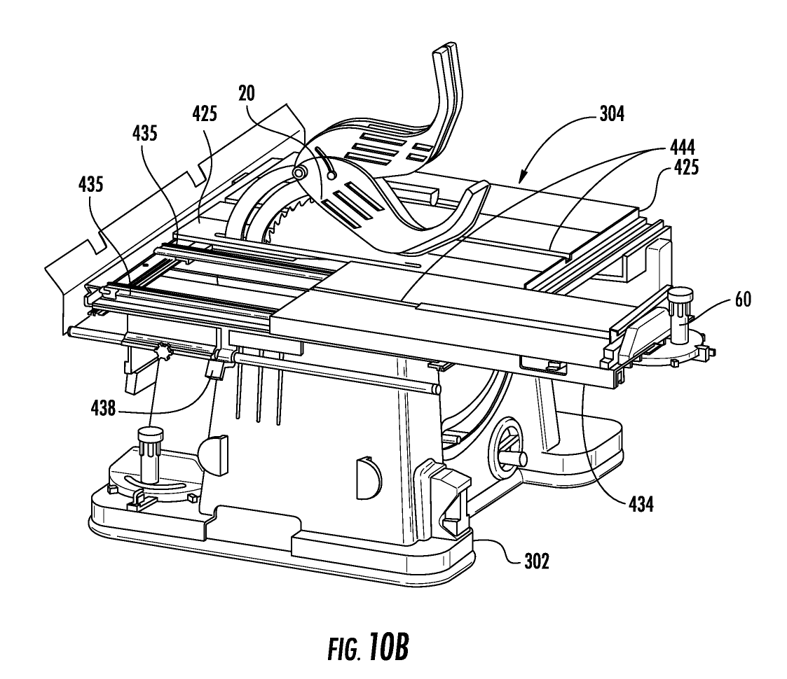

FIGS. 7-8 show the general configuration of the base 302 including a tubular sub-base 420, a base frame 422 and carry handles 423 integrated into the frame. The table assembly 304 includes a table frame 425 with mounting brackets 426 for mounting the table assembly to the base frame. The sub-base 420 may be a tubular structure, as shown in FIG. 9 and may be fastened to the base 302 to protect the base against damage. The tubular sub-base 420 includes tubular legs 421a-421f that form a perimeter that matches the perimeter of the base 302, as best seen in FIG. 6A. The sub-base may be formed form a single extruded tube that is bent to the perimeter configuration shown in FIG. 10A, or may be formed from tubular segments that are welded together. For example, the legs 421a-421e of the sub-base 420 may be formed as one piece since the bends are at a smooth radius. The final leg 421f may be welded to the ends of the legs 421a and 421e to complete the perimeter of the sub-base.

The table assembly 304 according to one aspect of the disclosure is illustrated in FIGS. 10A and 10B. The table assembly is of modular construction including a fixed table section 430, a throat plate insert 432, an optional sliding table section 434, and an optional extension table 442. Each table section 434, 442 may include a miter gauge assembly channel 444 for receiving a miter gauge assembly 60 or other suitable miter assembly. The extension table 442 includes front and rear rails 428, 429 for engagement to the table frame 425. A lock 436 may be provided to fix the extension table 442 to the fixed table section 430. The sliding table section 434 may also include a lock 438 for fixing the sliding table at a particular extended position. The sliding table section 434 is slidable mounted on rails 435 that are mounted to the table frames 425 as shown in the extended position depicted in FIG. 10B. As shown in FIG. 10B, the table section 434 is extended in a direction parallel to the saw blade and perpendicular to the width of the table assembly 304. A rear support 440 may also be provided as part of the table assembly 304.

As reflected in FIGS. 11A, 11B, and 11C, the table assembly components shown in FIG. 10A may be selected to tailor the power tool as desired by the operator or manufacturer. For instance, the entire table top assembly may include only fixed table sections 430 at the left and right sides of the power tool, as indicated by Example No. 1 in FIG. 11A. The left side fixed table may alternatively be replaced with a sliding table section 434, as indicated in Example No. 2. An appropriate fixed frame 425 or a sliding frame 425′ may be used (see FIG. 11B), depending on whether a sliding table section is included. The extension table 442 and its rails 428,429 can be omitted if desired. The throat plate 432 may be replaced by a special throat plate insert 432′ as desired. The special insert 432′ may be provided with a different blade slot configuration, such as a wider or narrower slot to account for different bevel angle capabilities. Likewise, a special frame 425″ may be used to configure the table top assembly 304. A top view of the table assembly with the alternative components is shown in FIG. 11C. It is understood that the interchangeable, modular extruded components may be sized in accordance with a conventional table for a power tool and as desired for a portable table. For example, a portable table as shown in FIG. 11C may have a width of 736 mm and a length of 558 mm. The left table extrusion 430/434 may have a width of 248 mm, the throat plate 432/432′ a width of 154 mm, the fixed right table 430 a width of 212 mm, and the extension table 442 a width of 139 mm, with all of the components having the same length of 558 mm.

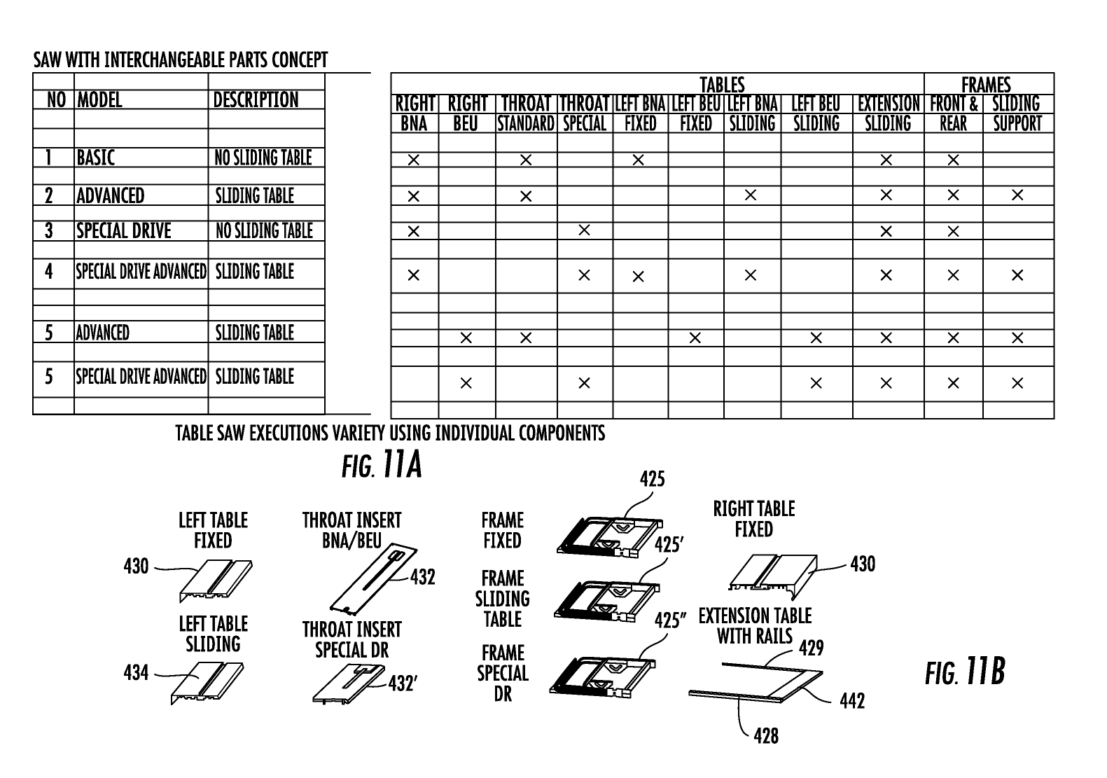

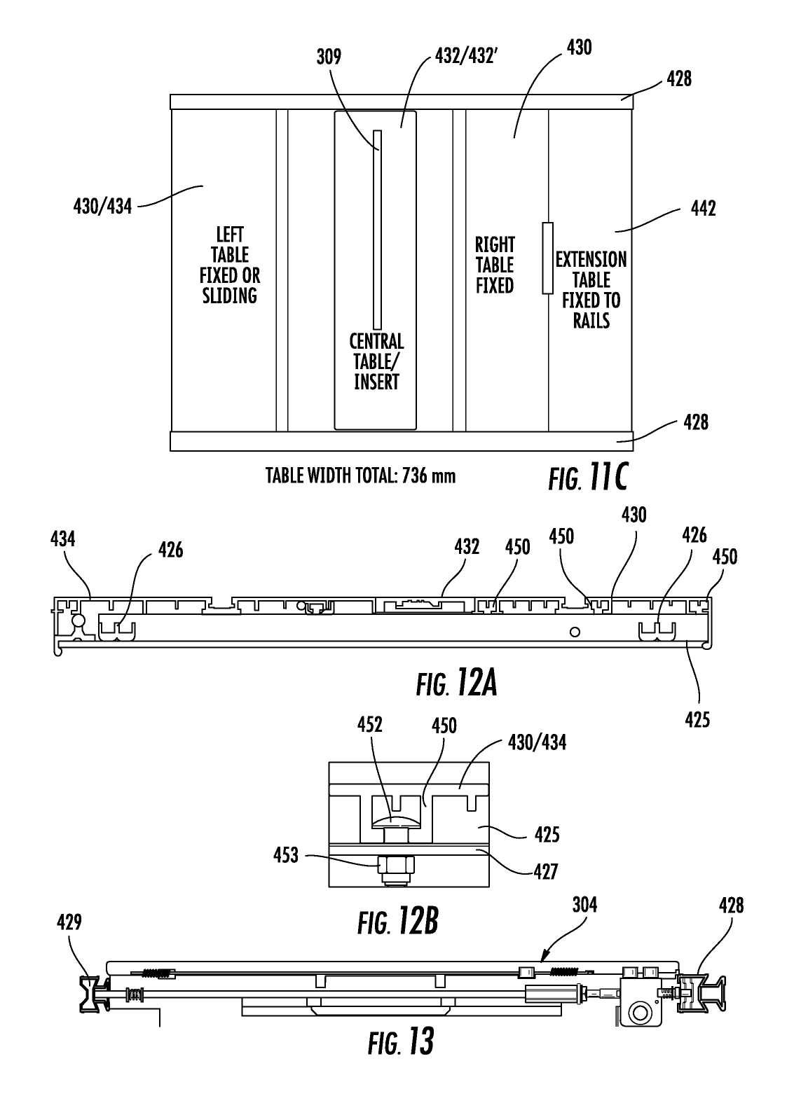

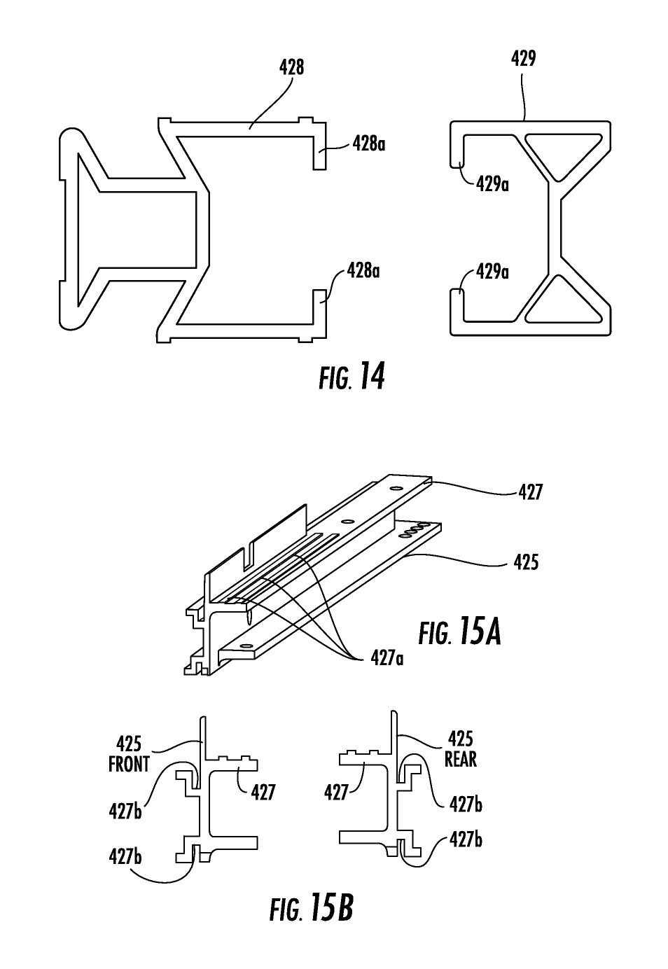

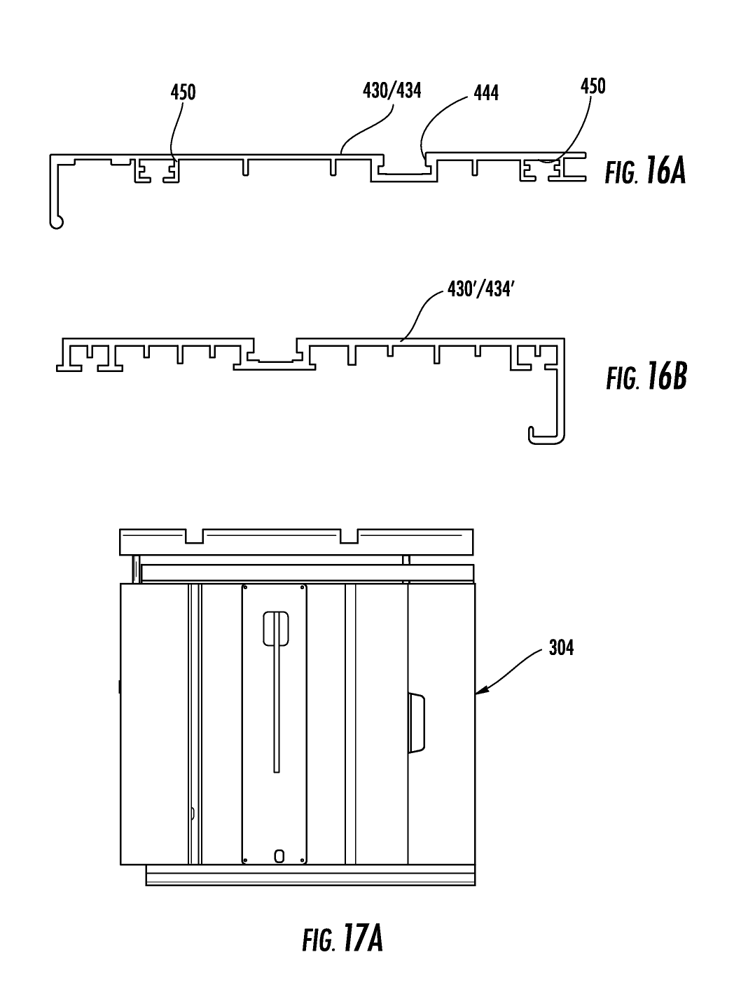

The modularity of the table assembly 304 may be achieved by providing the table sections and throat insert as extruded parts. Thus, as shown in FIGS. 12A, 12B, 13, 14, 15A, 15B, 16A, and 16B the fixed table section 430 may be an extruded component with bolt channels 450 defined in the underside of the extrusion. The bolt channels 450 are configured to receive carriage bolts 452, or similar fastener, that extend through bolt openings 427a in a flange 427 formed in the extruded table frame 425, as best shown in FIG. 12B. A nut 453 engages the bolt 452 to fasten the table section to the table frame. As reflected in FIG. 16A, the same extrusion can be used for the fixed table section 430 and the sliding table section 434, and can be modified to provide a different side panel configuration, as reflected by the extrusions 430′/434′ shown in FIG. 16B. Likewise, the front and rear frames may be the same extrusion 425, as shown in FIGS. 15A and 15B. As shown in FIG. 15A, the flange 427 of the extruded frame includes a plurality of openings 427a along the length of the extrusion for mounting of the table sections. The front and rear frames 425 thus simplify mounting selected table sections to form the completed table assembly. The front rail 428 and rear rail 429 may also be extrusions as shown in FIG. 14. The front and rear rails include corresponding inwardly facing flanges 428a, 429a that are configured to be disposed within opposite outwardly facing channels 427b defined in the table frames 425 (FIG. 15B). The rails are mounted to the table frames with the upper flange, such as flange 428a, disposed within the upper channel 427b, and the opposite lower flange disposed within the opposite lower channel to capture the rails on the table frames. However, it is understood that the orientation of the flanges and channels can be reversed so that the channels 427b face inward toward each other and the flanges 428a, 429a face outward away from each other. The flanges 428a, 429a can be co-extensive with the length of the table frames 425 to provide a firm support for the table extension 442. The sliding table frame 425′ may incorporate a similar flange-channel construction to permit sliding movement of a table section.

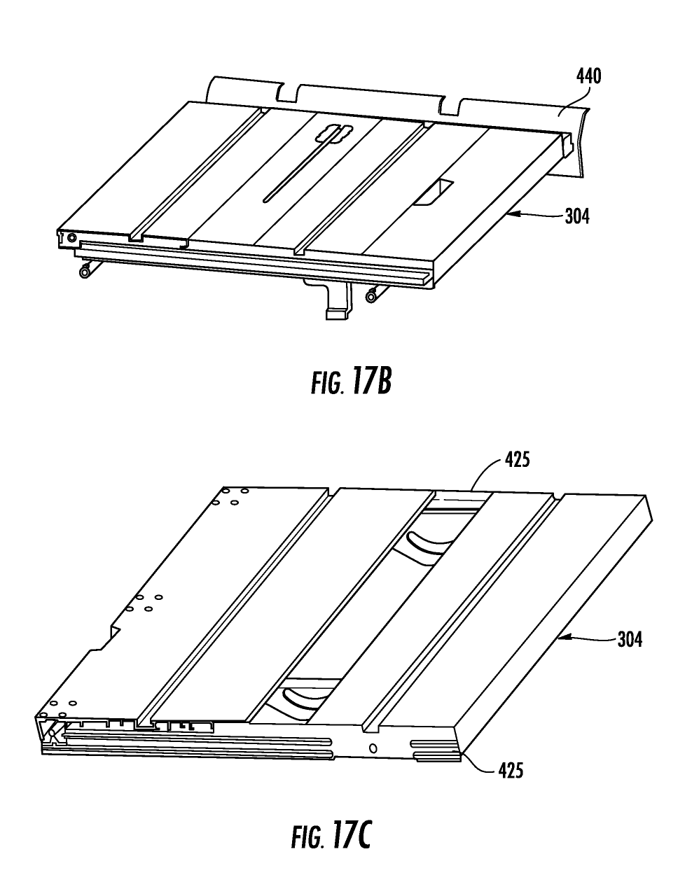

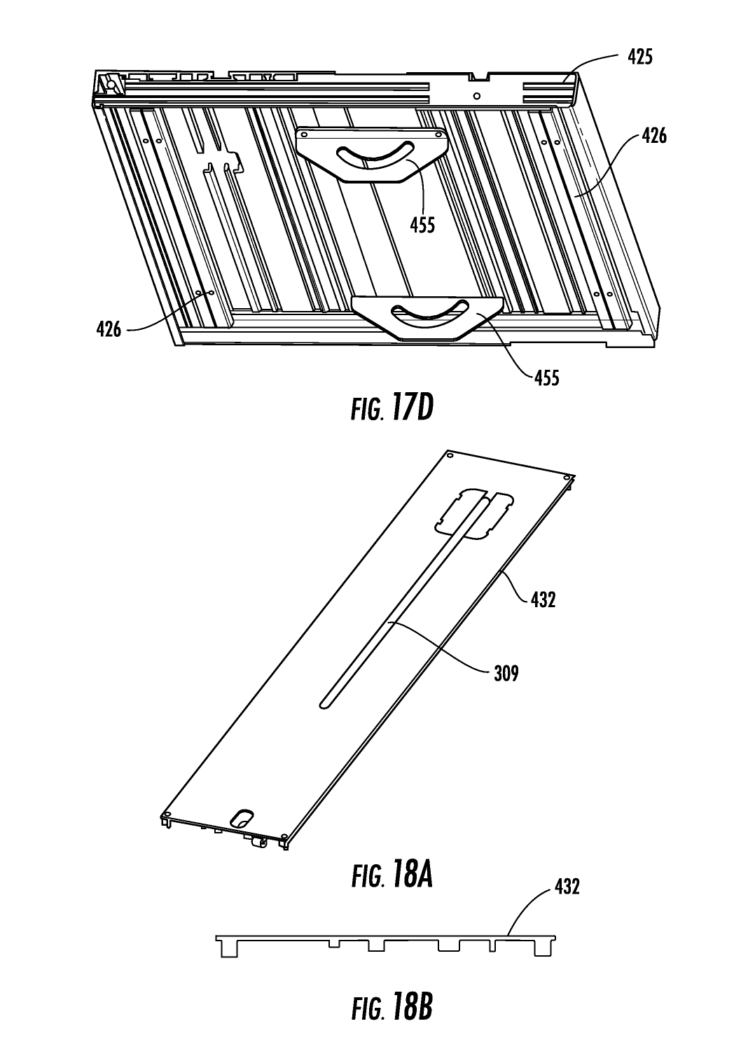

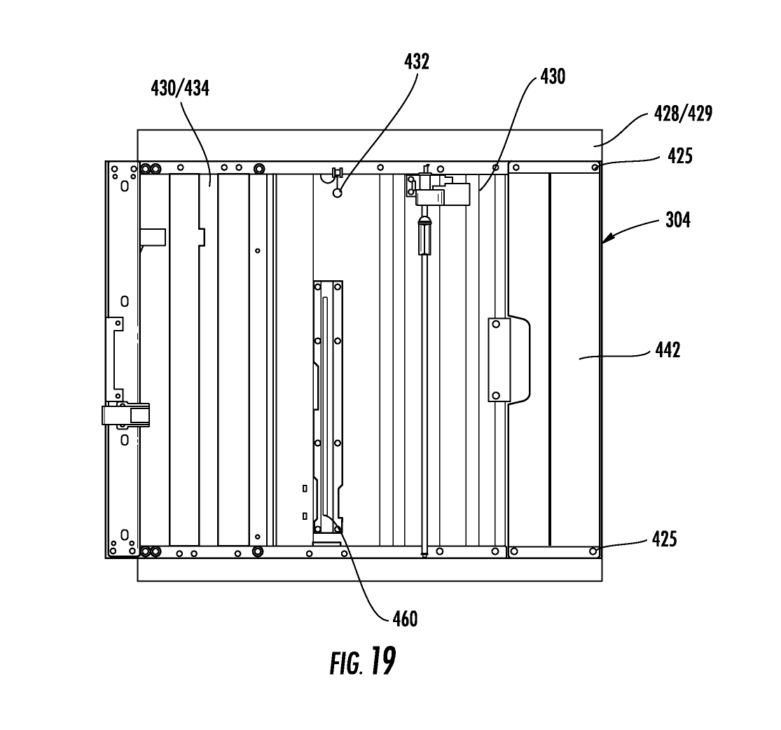

It can be noted that the extrusions for the table sections facilitate fastening to the mounting brackets 426 and bevel brackets 455, as shown in FIG. 17D. The throat plate 432 may also be an extruded part, as shown in FIGS. 18A and 18B.

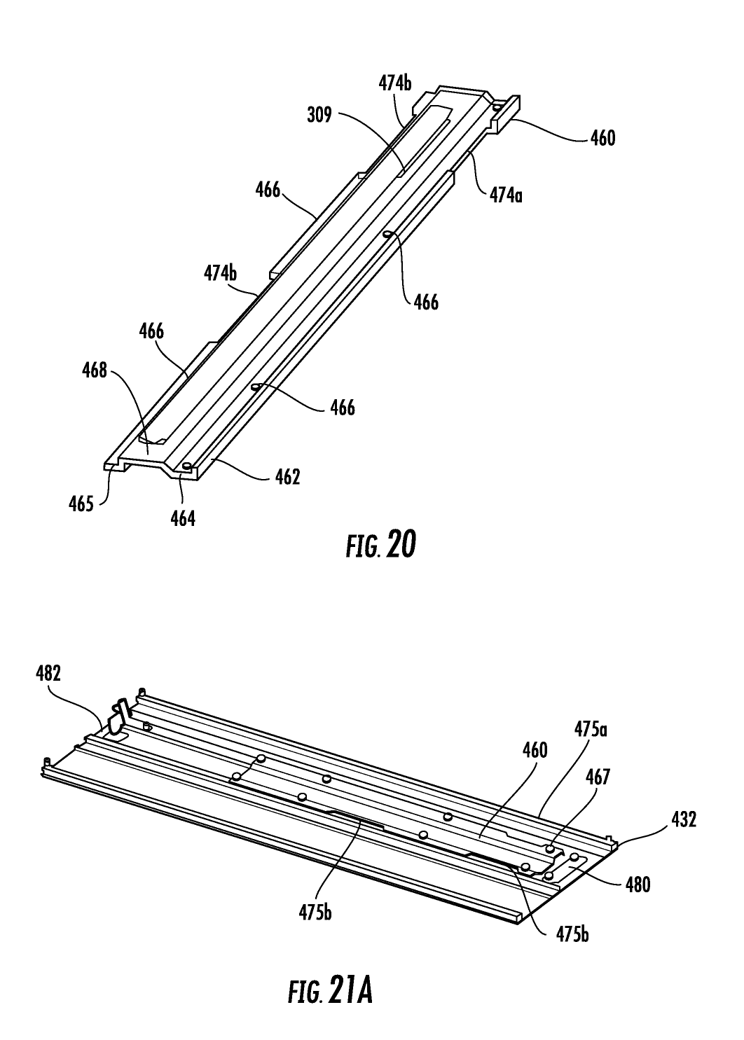

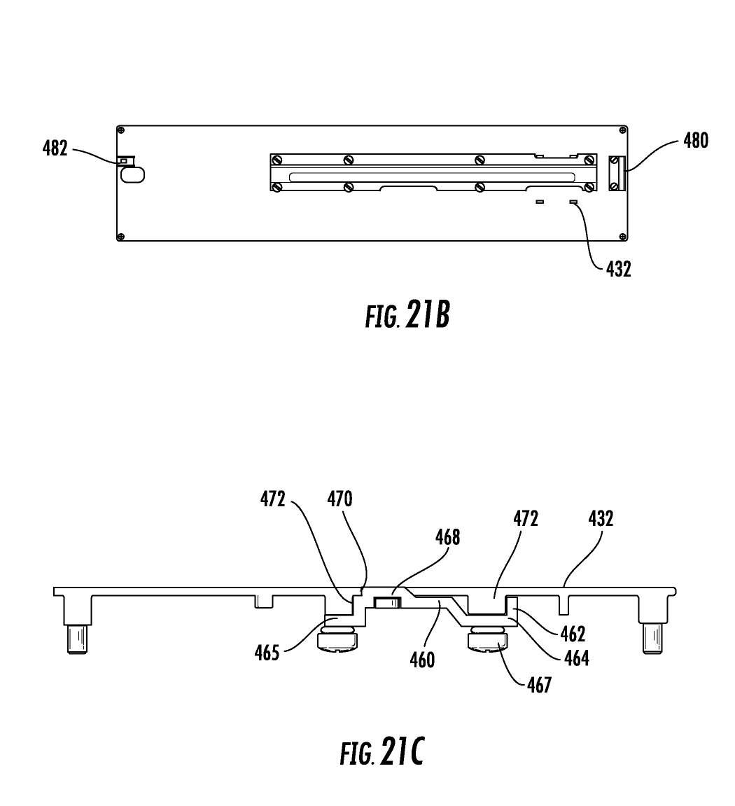

The table assembly 304 described above includes a modular throat plate 432 that can be fastened to the table frame 425, as shown in FIG. 19. The throat plate 432 includes a zero clearance insert 460 that defines the blade slot 309 for the table saw. As shown in FIG. 20, the insert may be an extruded part that includes an alignment flange 462 extending upward from a lateral mounting flange 464 along one side of the insert 460. A mounting flange 465 is provided on the opposite side of the insert, with each mounting flange including a plurality of openings 466 for receiving fasteners 467 to mount the insert to the throat plate 432, as illustrated in FIGS. 21A, 21B, and 21C. The insert further defines a surface plate 468 that is arranged to seat within the slot 470 defined in the throat plate. As reflected in FIG. 21C, the alignment flange 462 is configured to abut a mounting rib 472 on the underside of the throat plate 432. The alignment flange thus helps establish and maintain an accurate alignment between the insert and the throat plate when the insert is fastened to the throat plate by the fasteners 467. The proper orientation of the insert 460 is established by a notch-tab arrangement in which a single notch 474a (FIG. 20) mates with a single tab 475a (FIG. 21A) on one side of the insert while a pair of notches 474b mate with a corresponding pair of tabs 475b on the opposite side of the insert. The notches and tabs thus serve as a coding element to ensure that the insert is fastened in a proper orientation.

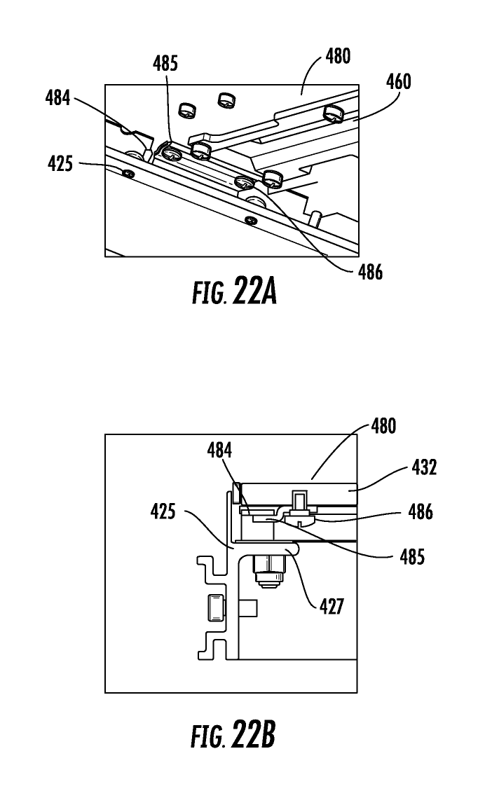

The throat plate 432 is a modular component of the table assembly 304 and can be removed and replaced as desired. The throat plate thus includes a rear latch 480 and a front latch assembly 482 that allows the plate to be engaged and released from the table frame 425 (FIG. 21A). As shown in the detail views of FIG. 22A and 22B, the rear latch 480 is a stationary latch that includes a plate 485 configured to seat beneath a ledge 484 mounted to the flange 427 of the table frame 425. The ledge 480 may be a U-shaped bracket mounted to the flange. A fastener 486 fixes the plate 485 to the underside of the throat plate 432. As can be appreciated, the plate 485 is configured to allow the throat plate to be introduced into the table frame 425 at an angle and then pivoted downward until the throat plate is generally flush with the fixed table section 430 as illustrated in FIG. 23.

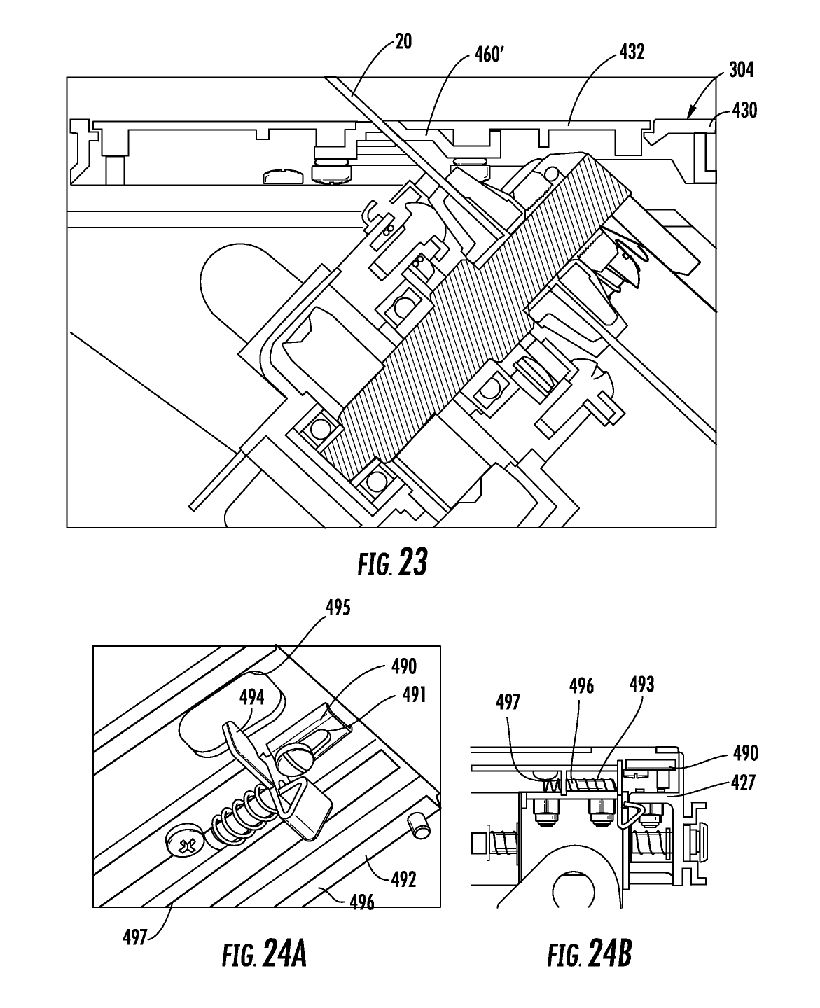

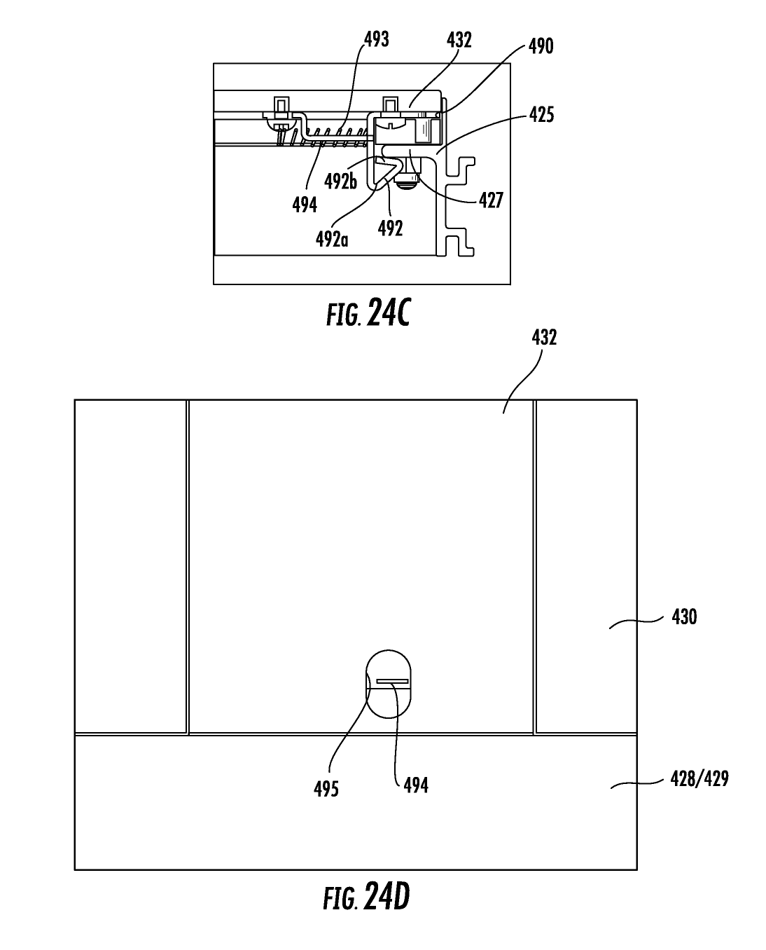

The front latch assembly 482 is configured to automatically engage the ledge 427 of the table frame 425 (FIG. 12B) to fix the throat plate to the table. The assembly 482, shown in detail in FIGS. 24A, 24B, 24C, and 24D, includes a latch element 490 that is mounted for translation to the underside of the throat plate by a suitable fastener extending through an elongated slot 491 in the latch element. The latch element includes a catch 492 that is generally triangular in shape so that the catch moves axially when the angled surface 492a contacts the ledge 427. The upper surface 492b of the catch is generally flat and slightly angled to engage the underside of the ledge, as depicted in FIG. 24C. A spring 493 is supported on a post 496 extending inward from the latch element 490. The spring 493 bears against a flange 497 so that the spring biases the latch element to the locked position shown in FIGS. 24A, 24B, 24C, and 24D. A release lever 494 is provided that is fastened to the latch element to withdrawn the element from engagement with the ledge 427. The lever 494 may be manually engaged through an opening 495 in the throat plate 432. The throat plate may also include indicia showing alignment of the lever with either a locked or an unlocked position. The indicia provides the operator with a visual verification that the throat plate 432 is indeed locked to the table assembly before the tool is operated.

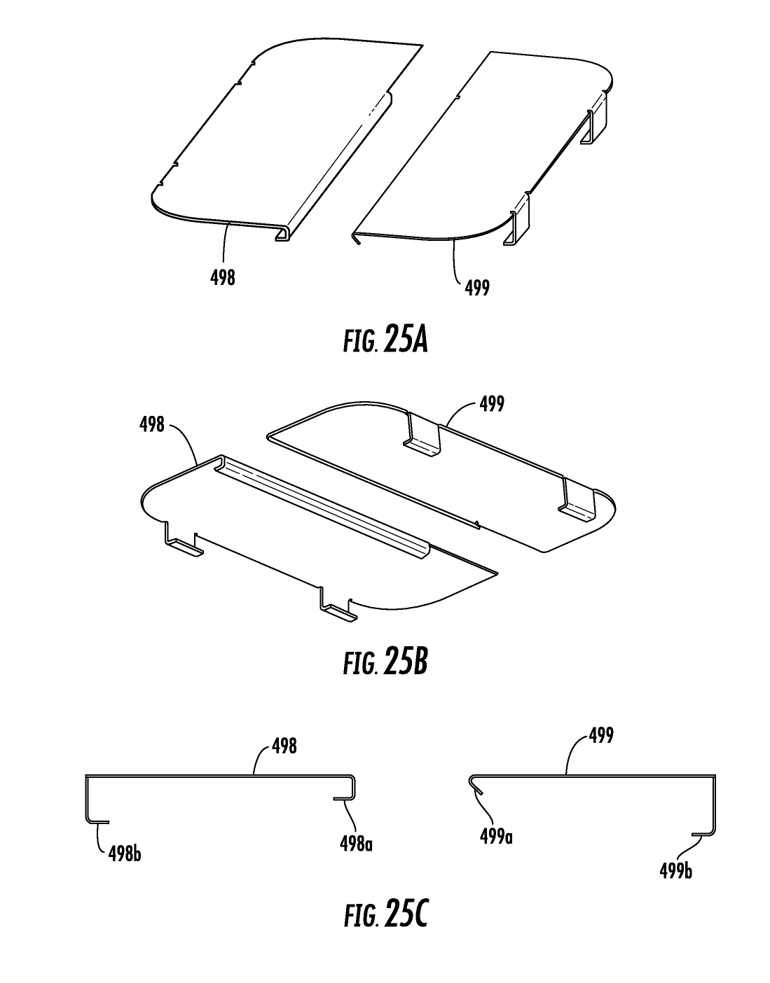

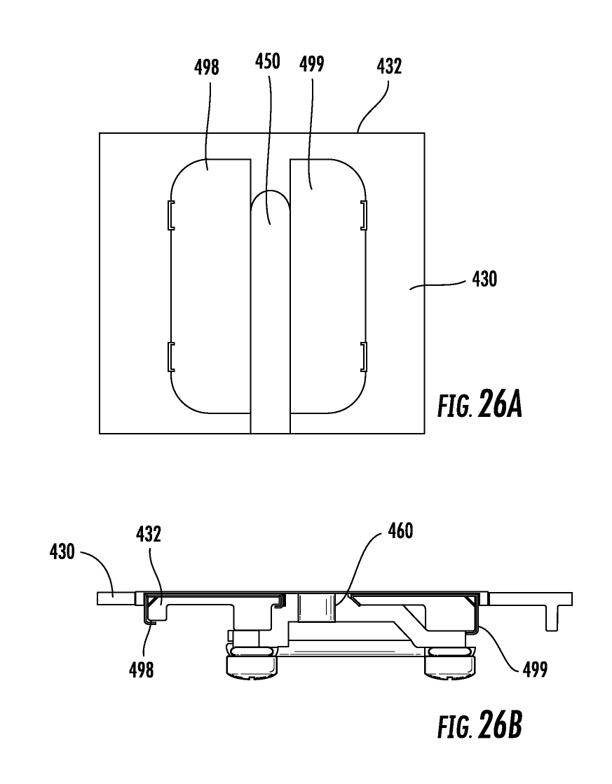

In another aspect, hardened plates 498, 499 may be mounted on the throat plate 432 prior to mounting on the table assembly. As shown in FIGS. 25A, 25B, 25C the hardened plates include brackets 498a, 498b, 499a, 499b on opposite sides of the plates that are configured to slide onto the throat plate 460, as illustrated in FIGS. 26A and 26B.

According to one aspect of the disclosure, modular extruded components can be used to build a table for a table saw according to the operator's or manufacturer's desire. The same extruded table section may be used for left and right fixed table sections or for one fixed and one sliding table section. The table frames are also extruded and can be used interchangeably on the front or back of the power tool. Likewise, the front and rear rails used to mount an extension table to a fixed table section are also extruded and interchangeable. The modular components may be assembled and fixed to each other and/or the table frame using standard fasteners, such as screws. The extruded components may e extruded from material traditionally used for power tools, such as aluminum or stainless steel. The extruded construction minimizes the amount of material required for the components, and thus reduces the weight of the power tool.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

What is claimed is:

1. A modular table for a power tool comprising:
a base configured to be seated on a surface;
an undercarriage assembly supporting working components of the power tool including a saw blade;
a table assembly mounted on the base and supporting the undercarriage assembly, the table assembly including;
a table frame;
a selection of table sections removably mounted to the table frame, the table sections selected from the group including a fixed table section, a table extension including rails for mounting to the table frame, and a sliding table section including a sliding frame for slidably mounting to the table frame; and
a throat plate removably mounted to a table frame, the throat plate defining a slot for receiving the saw blade therethrough.

2. The modular table of claim 1, wherein the fixed table section is configured to be removably mounted at either end of the width of the table assembly.

3. The modular table of claim 1, wherein:
the table frame includes identical elongated frame members extending along the width of the table assembly on opposite sides thereof, the frame members including an elongated flange defining a plurality of openings therethrough;
each of said fixed table sections includes a bolt channel; and
the modular table further comprises fasteners configured to engage the plurality of openings and the bolt channel of each fixed table section mounted to the table frame.

4. The modular table of claim 3, wherein:
each elongated frame member includes opposite channels extending along the length of the frame member; and
the table extension includes opposite rails configured to engage the opposite channels of the frame members.

5. The modular table of claim 1, wherein the table extension and sliding table include a channel for mounting a miter gauge to the table.

6. The modular table of claim 1, wherein the throat plate includes a zero clearance insert fastened to the throat plate in the slot.

7. The modular table of claim 1, wherein the throat plate is an elongated plate and includes a latch element at the opposite ends thereof, each latch element configured to engage the table frame.

8. The modular table of claim 7, wherein:
the table frame includes identical elongated frame members extending along the width of the table assembly on opposite sides thereof, the frame members including an elongated flange;
one of the elongated frame members includes a ledge fastened to the flange; and
one of the latch elements includes a plate fastened to the throat plate and arranged to extend between the ledge and the flange of the one elongated frame member.

9. The modular table of claim 8, wherein the other of the latch elements includes a spring-biased element configured to engage the flange of the other of the elongated frame members when the one latch element is engaged to the one elongated frame member.

10. The modular table of claim 9, wherein the other of the latch elements includes a manually engagable lever operable to move the spring-biased element away from the flange to disengage the throat plate from the table frame.

11. The modular table of claim 10, wherein the throat plate includes an opening through which the lever may be engaged.

12. A table for a power tool comprising:
a base configured to be seated on a surface;
an undercarriage assembly supporting working components of the power tool including a saw blade;
a table assembly mounted on the base and supporting the undercarriage assembly, the table assembly including;
a frame;
one or more table sections mounted to the frame; and
a throat plate mounted to at least one of the one or more table sections, the throat plate defining a slot for receiving the saw blade therethrough,
wherein the one or more table sections and the throat plate are extruded.

13. The modular table of claim 12, wherein the throat plate includes a zero clearance insert fastened to the throat plate in the slot.

14. The modular table of claim 12, wherein the throat plate is an elongated plate and includes a latch element at the opposite ends thereof, each latch element configured to engage the table frame.

15. The modular table of claim 14, wherein:
the table frame includes identical elongated frame members extending along the width of the table assembly on opposite sides thereof, the frame members including an elongated flange;
one of the elongated frame members includes a ledge fastened to the flange; and
one of the latch elements includes a plate fastened to the throat plate and arranged to extend between the ledge and the flange of the one elongated frame member.

16. The modular table of claim 15, wherein the other of the latch elements includes a spring-biased element configured to engage the flange of the other of the elongated frame members when the one latch element is engaged to the one elongated frame member.

17. The modular table of claim 16, wherein the other of the latch elements includes a manually engagable lever operable to move the spring-biased element away from the flange to disengage the throat plate from the table frame.

18. The modular table of claim 17, wherein the throat plate includes an opening through which the lever may be engaged.
